(19) United States
(12) Patent Application Publication
(10) Pub. No.: US 2006/0042098 A1
(43) Pub. Date: Mar. 2, 2006

(54) S-shaped knife

(76) Inventor: Miguel Morales, Dulzura, CA (US)

Correspondence Address: Miguel Morales, P.O. Box 32, Dulzura, CA, 91917, US

(21) Appl. No.: 10/933,620

(22) Filed: Sep. 2, 2004

(51) Int. Cl. B26B 3/00

(52) U.S. Cl. 30/298; 30/314

(57) ABSTRACT

A Knife is disclosed. The knife has a stronger blade for more durability and utility. The knife further forms an “S” shape with the knife handle to give the user additional use cases. The knife further is formed with a blade that has both a single-beveled edge and a double-beveled edge. A saw-toothed portion is provided to made the knife well suited for hunting and fishing applications. Still further, one or more thumb or finger rests are formed on the knife and/or handle to give the user better control of the device.

### BACKGROUND OF THE INVENTION

1. Field of the Invention

This invention relates generally to cutting apparatus and, more specifically, to an S-shaped Knife.

2. Description of Related Art

Hunting and other specialty knives have become extremely popular to today's sportsmen. In fact, one particular knife used in Indochinese fighting is known as the Karambit. The Karambit, which means tiger claw, revolutionized the knife industry and has become extremely popular. In fact, they have become so popular they are available in prices exceeding $300 or $400 per knife for a fairly standard knife. If we turn to FIG. 1, we can examine what a conventional Karambit includes.

The Karambit 10, in its version shown here, is generally a “C”-Shaped Device. The Device 10 has three general sections; the Blade 12, the Handle 14 and the Heel 16. The Knife 10 is generally flat and defines a Top Edge 18 and a Bottom Edge 20; the Top Edge 18 being concave and the Bottom Edge 20 being convex to form the “C” shape referred to above. The Heel 16 is defined by a Ring 22, which is generally circular in shape and forms a Finger Aperture 24 there through. The Blade 12 defines a Concave Blade Edge 26 which is sharpened, a Convex Blade Edge 28 which is also sharpened, that converge to form a Tip 30. There are typically a plurality of Teeth 32 near the section known as the Transition Section 34 between the Handle 14 and the Blade 12. The Handle 14 defines a Concave Grip Edge 36 and a Convex Grip Edge 38. The Concave Grip Edge 36 generally has three or more Finger Indents 40 formed on its edge.

If we now turn to FIG. 2, we can see how one might use a conventional Karambit. FIG. 2 is a side view of an individual holding a Conventional Fixed Blade Karambit 10. In this position, the user is gripping the Handle 14 in his Hand 44 with the Index Finger 46 threaded through the Ring 22. In this position, the Tip 30 and Concave Cutting Edge 26 of the Blade 12 are facing forward and one could imagine that a punching motion would result in the Tip 30 and Concave Cutting Edge 26 being driven towards the assailant. While not shown here, one technique with the Karambit 10 is for the user to release his or her grasp on the Handle 14 and then pivot the Knife 10 around their Index Finger 46 on the Ring 22. This provides an extension aspect to the Karambit 10.

There are at least three problems associated with the Karambit design. First, while the C-shape can be somewhat useful for tactical uses, it is not a very useful shape for hunting, fishing and other utility purposes. Second, the blade of the Karambit has double-bevelled blade edges on both the concave and convex sides—again, this is fine for tactical use, but the device is otherwise limited. Finally, the relatively small size of the side of the blade reduces the strength of the blade when used in utility applications.

### SUMMARY OF THE INVENTION

In light of the aforementioned problems associated with the prior devices, it is an object of the present invention to provide an S-shaped Knife. The knife should have a stronger blade for more durability and utility. The knife should further form an “S” shape with the knife handle to give the user additional use cases. The knife should further be formed with a blade that has both a single-beveled edge and a double-beveled edge. A saw-toothed portion should further be provided to made the knife well suited for hunting and fishing applications. Finally, one or more thumb or finger rests should be formed on the knife and/or handle to give the user better control of the device.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a side view of a conventional fixed blade Karambit;

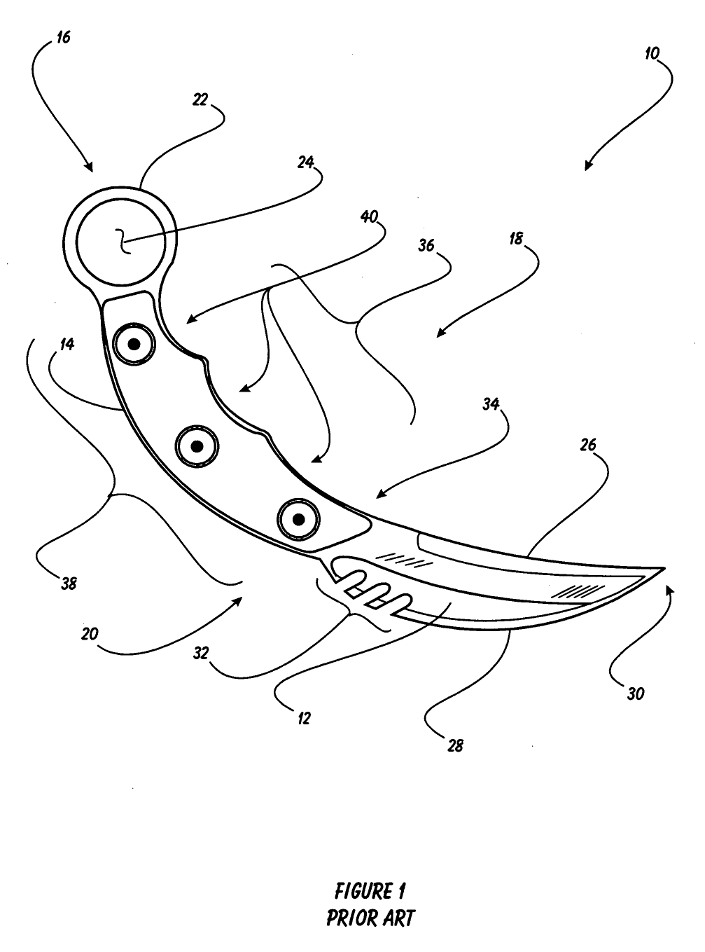

FIG. 2 is a side view of a user grasping the Karambit of FIG. 1;

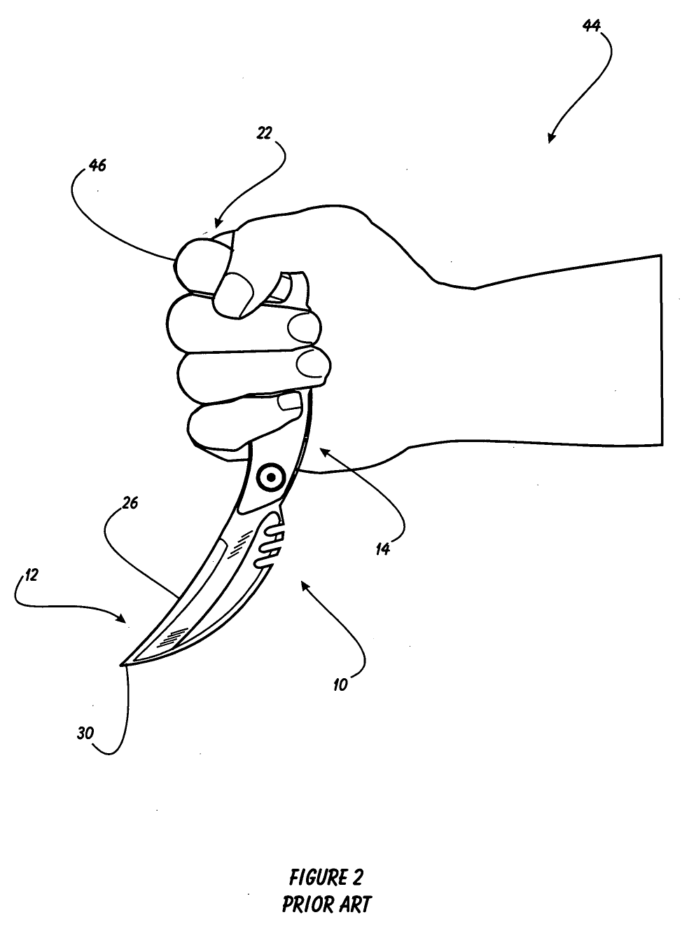

FIG. 3A is a side view of a preferred embodiment of the “S”-Shaped Knife of the present invention; FIG. 3B is a cross-section view of the blade of the Knife of FIG. 3A;

FIG. 4 is a side view of a user grasping the Knife of FIG. 3 in a first grasping position; and

FIG. 5 is a side view of the Knife of FIGS. 3 and 4 in a second grasped position.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an S-shaped Knife.

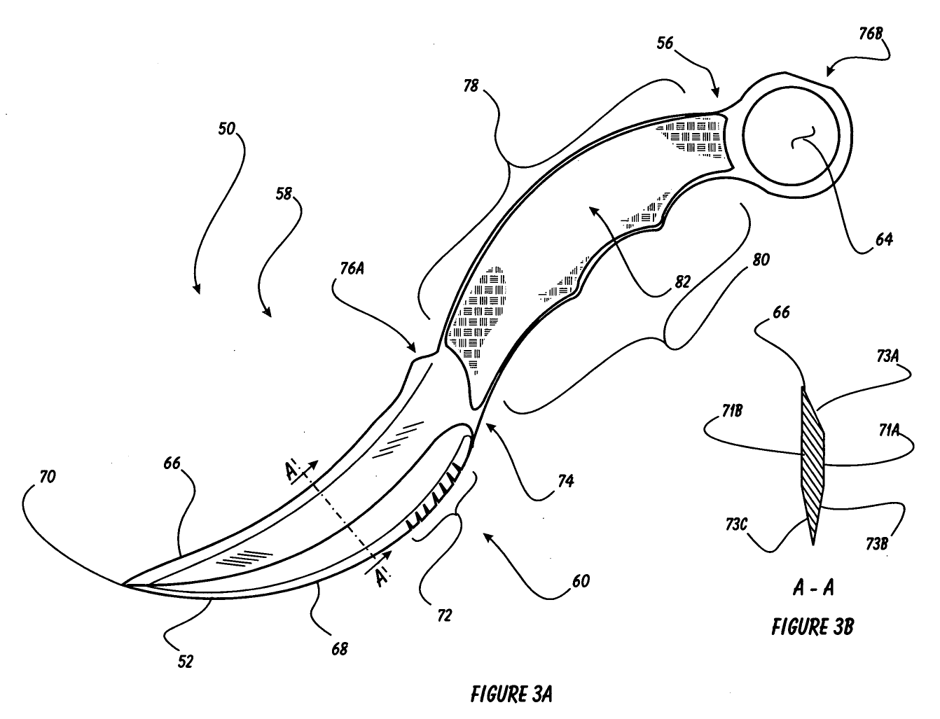

FIG. 3A is a side view of a preferred embodiment of the “S”-Shaped Knife of the present invention. The “S”-Shaped Knife 50 also has three main sections; the Blade 52, the Handle 54 and the Heel 56. It further defines a Top Edge 58 and a Bottom Edge 60. The Blade 52 defines a Concave Blade Edge 66 on its top edge and a Convex Blade Edge 68 on its bottom edge. These Edges 66 and 68 terminate in a Tip 70. Rather than the deep teeth included in the prior design, the “S”-Shaped Knife 50 of the present invention preferably has a plurality of Saw Grooves 72 formed adjacent to the Transition Section 74 on the Bottom Edge 60 on the Knife 50. The Saw Grooves 72 are designed as such (much shallower than the teeth in the prior Karambit) to provide utility for sawing through wood or bone. There is further a Thumb Rest 46A formed on the Top Edge 58 of the Knife 50 between the Blade 52 and the Handle 54. The Thumb Rest 46A may also be provided with serrations or grooves on its surface in order to improve gripping.

Similar to the previous designs, the Handle 54, here, has a Convex Grip Edge 78 and a Concave Grip Edge 80 defined by a plurality of Finger Indents 82. The difference here is that the Convex Grip Edge 78 is on the Top Edge 58 of the Handle 54 rather than the Bottom Edge 60 as disclosed in the prior design. Furthermore, the Concave Grip Edge 80 is the Bottom Edge 60 of the Handle 54, which is also opposite to the prior design. The result is to form an “S”-Shaped Knife rather than a “C”-Shaped Knife. This shape distinction provides substantial utility to the user. The Heel 56 is defined by a Ring 62 which has a Finger Aperture 64 formed through it. On one section of the periphery of the Ring 62, a second Thumb Rest 76b is formed. The ring 62 (also called a retention ring), works to prevent slippage of the knife in the user's hand. The ring 62 can also be used as a hand grip or handle.

FIG. 3B is a cross-sectional view of the blade 52 along line A-A in FIG. 3A. The blade 52 is defined by a double-beveled convex blade edge 68, and a single-beveled concave blade edge 66. The blade has a front flat portion 71A and a rear flat portion 71B. The front flat portion 71A extends between a first bevel face 73A and a second bevel face 73B. The rear flat portion 71B extends between the first bevel face 73A and a third bevel face 73C. As such, the intersection of the rear flat portion 71B and the first bevel face 73A forms a single-beveled concave blade edge 66. The intersection of the second bevel face 73B and the third bevel face 73C forms a double-beveled convex blade edge 68.

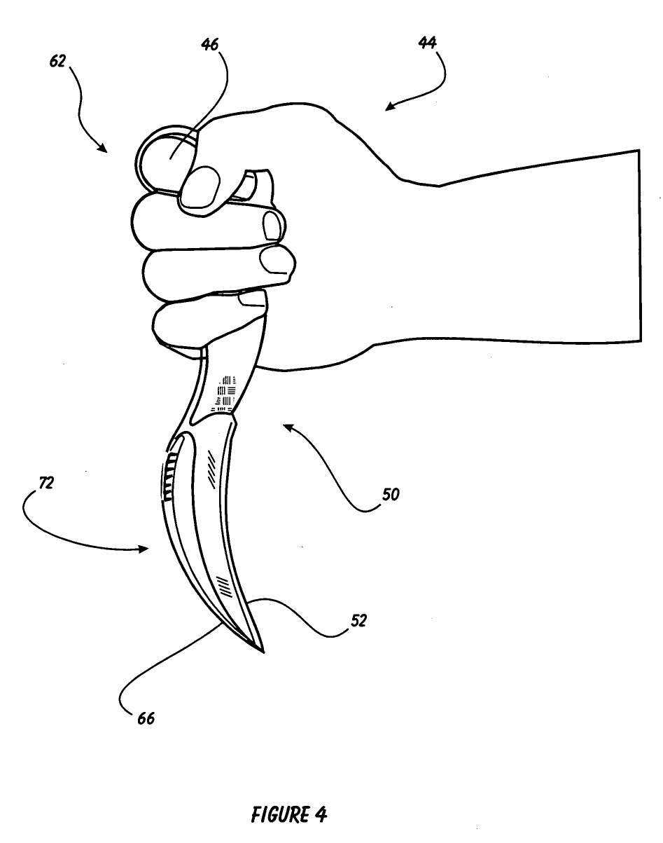

The single-beveled concave blade edge 66 will cause the blade 52 to cut more deeply into flesh, etc. when the user pulls the knife 50 towards the concave blade edge 66 (a “back slash”). Also, having a flat rear portion Furthermore, the front flat portion 71A is enlarged in the knife 50, as compared to the prior Karambit, to provide additional stiffness and durability. Both of these features make the knife 50 more versatile than the prior art knives. If we now turn to FIG. 4, we can see how the Knife of the present invention provides additional utility to the user.

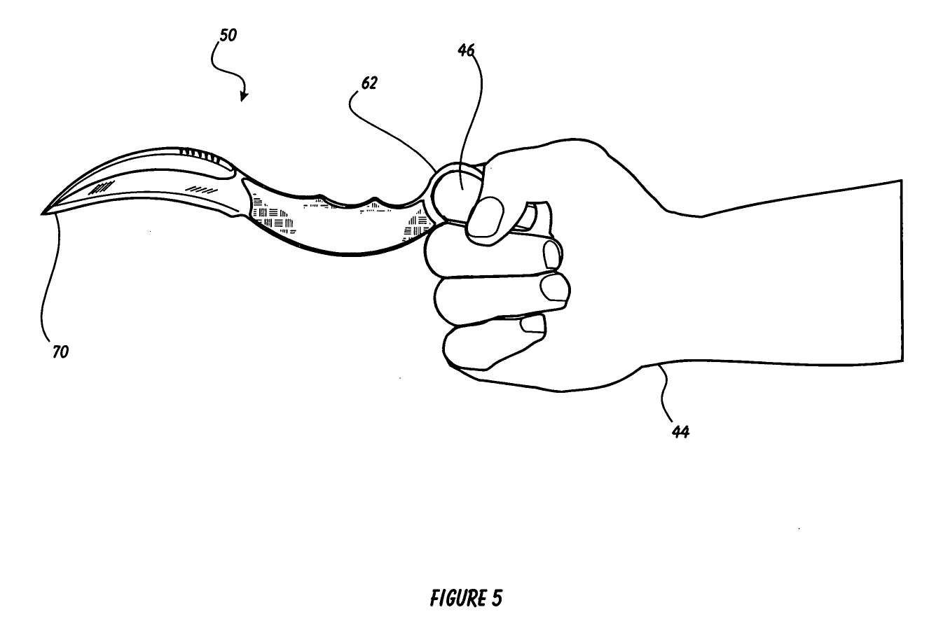

FIG. 4 is a side view of a user grasping the Knife of FIG. 3 in a first grasping position. When the user grasps the Knife 50 of the present invention in his Hand 44 and with his Index Finger 46 inserted through the Ring 62, one can see that the Convex Cutting Edge 68 of the Blade 52 is facing forward. Of course, the Saw Grooves 72 are also facing forward. This orientation will provide the user with a slashing effect when the user swings his hand in a punching motion. Rather than puncturing the assailant therefore, this user will slash. It has been demonstrated this is a preferred approach in hand-to-hand fighting. An additional benefit of this “S”-Shaped Design is demonstrated by FIG. 5.

FIG. 5 is a side view of the Knife of FIGS. 3 and 4 in a second grasped position. By virtue of the Thumb Rest 76b formed on the Ring 62, the user obtains additional leverage when he or she is using the knife 50 in a slashing motion. Furthermore, the Tip 70 of the Knife 50 will be oriented to point forward providing it additional extension distance between the Tip 70 and the Hand 44 to create a greater zone of defense for the user.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A knife, comprising:
a heel;
a C-shaped handle extending from said heel;
a C-shaped blade extending from said handle, said blade and said handle cooperatively oriented to create a combined S-shape.

2. The knife of claim 1, wherein said heel further defines a ring defining an outer periphery and a finger aperture formed therethrough, said outer periphery defined by a thumb rest formed thereon.

3. The knife of claim 2, wherein said knife defines a top edge and a bottom edge, and wherein said handle defines a convex grip edge on said top edge and a concave grip edge on said bottom edge.

4. The knife of claim 3, wherein said blade defines a concave blade edge on said top edge and a convex blade edge on said bottom edge.

5. The knife of claim 4, further defined by a transitional section between said handle and said blade, said knife further defining a second thumb rest adjacent to said transitional section.

6. The knife of claim 5, further defined by a plurality of saw grooves formed in said convex blade edge adjacent to said transitional section.

7. A knife, comprising:
a heel, said heel further defines a ring defining an outer periphery and a finger aperture formed through said ring, said outer periphery defined by a thumb rest formed thereon;
a handle extending from said heel; and
a blade extending from said handle.

8. The knife of claim 7, wherein said knife defines a top edge and a bottom edge, and wherein said handle defines a convex grip edge on said top edge and a concave grip edge on said bottom edge.

9. The knife of claim 8, wherein said concave grip edge further defines one or more finger indents formed therein.

10. The knife of claim 9, wherein said blade defines a concave blade edge on said top edge and a convex blade edge on said bottom edge.

11. The knife of claim 10, further defined by a transitional section between said handle and said blade, said knife further defining a second thumb rest adjacent to said transitional section.

12. The knife of claim 11, further defined by a plurality of saw grooves formed in said convex blade edge adjacent to said transitional section.

13. A knife, comprising a top edge and a bottom edge, and a handle defining a convex grip edge on said top edge and a concave grip edge on said bottom edge.

14. The knife of claim 13, wherein said blade defines a concave blade edge on said top edge and a convex blade edge on said bottom edge.

15. The knife of claim 14, further comprising a heel, said heel further defines a ring defining an outer periphery and a finger aperture formed through said ring, said outer periphery defined by a thumb rest formed thereon.

16. The knife of claim 15, wherein said concave grip edge further defines one or more finger indents formed therein.

17. The knife of claim 16, further defined by a transitional section between said handle and said blade, said knife further defining a second thumb rest adjacent to said transitional section.

18. The knife of claim 17, further defined by a plurality of saw grooves formed in said convex blade edge adjacent to said transitional section.

19. The knife of claim 4, wherein said concave blade edge comprises a first bevel face intersecting a rear flat portion.

20. The knife of claim 19, wherein said convex blade edge comprises a second bevel face intersecting a third bevel face, said third bevel face further intersecting said rear flat portion.
